(19) United States
(12) Patent Application Publication
(10) Pub. No.: US 2006/0292914 A1
(43) Pub. Date: Dec. 28, 2006

(54) Lighting unit, holder lamp and luminaire

(75) Inventors: Godefridus Nicolaas Maria Verspaget, Turnout (BE); Helmut Willnat, Kierspe (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/570,436

(22) PCT Filed: Aug. 23, 2004
(86) PCT No.: PCT/IB04/51528

§ 371 Date: Mar. 2, 2006

(30) Foreign Application Priority Data
Sep. 5, 2003 (EP) 03077815.3

(51) Int. Cl. H01R 13/625

(52) U.S. Cl. 439/337

(57) ABSTRACT

A lighting unit comprising a lamp and a holder, the lamp comprising a socket, an electric element arranged in a lamp vessel. The socket comprises protruding electrical lamp contacts having radially projecting ends. The holder comprises a walled housing in which electrical holder contacts and contact openings are provided. Upon insertion of the ends into the openings and after subsequent rotation of the lamp, the lamp base and the holder are pressed in axial direction towards one another by a spring force as a result of resilient hooking up of the lamp contacs behind the holder contacts. The spring force is temporarily, seemingly enhanced by reliefs on the lamp and holder surfaces, which reliefs mutually snugly fit once the lamp and holder are assembled. The inventive lighting unit enables accurate positioning of the electric element with respect to the holder.

The invention relates to a lighting unit comprising a lamp and a holder, the lamp comprising a socket, an electric element arranged in a lamp vessel mounted in the socket, and a lamp axis extending through the lamp vessel and the socket, the socket comprising a lamp base transverse to the lamp axis, the lamp base being provided with protruding electrical lamp contacts having radially projecting ends;

the holder comprising a walled housing in which electrical holder contacts are provided, while the housing has contact openings provided into a support wall transverse to a holder axis, the support wall has an outer wall surface, after insertion of the ends into the openings and subsequent rotation of the lamp about its lamp axis, the support wall is retained by the ends, the lamp base and the holder are pressed in axial direction towards one another by a spring force, and the lamp contacts are in electrical contact with the holder contacts.

The invention further relates to a holder and a lamp for use in said lighting unit and a luminaire comprising said holder or said lighting unit.

The lighting unit as described in the opening paragraph is known from EP-871264 A1. In the known unit the lamp has two lamp contacts shaped as contact pins. The housing of the holder defines two chambers for receiving the contact ends through two contact openings. The contact ends of the pins are heads which contact the electrical contacts in the chambers in a resilient manner when the pins are inserted into the contact openings and the pins project into the chambers. The contact openings extend arc-shaped on the support wall of the housing, the width of a first portion of each contact opening being greater than the width of the pin head, while a second portion of each contact opening has a width which is smaller than the width of the pin head but greater than the width of the pin itself. When the lamp is turned in the contact openings, the lamp base supporting the pins is pulled against the support wall of the housing by a metal spring which simultaneously exerts both an axially directed force and a radially directed force on the pins. This support wall constitutes a reference surface for the light cone which is to issue from the electric element of the lamp, so that the precise height of the housing can be adjusted relative to an optical system or another component where this precise alignment is of importance. It is achieved in the known lamp that the lamp base and the holder are pressed in axial direction to one another, but without any axial displacement of the electric element with respect to the holder after insertion of the ends in the openings. Said axial displacement is undesired as the distance between the holder and the electric element, known as the Light-Center-Length (LCL), is increased thereby, which is disdavantageous for accurate positioning of the electric element with respect to the reference surface of the holder. It is a disadvantage of the known unit that it requires a relatively complicated structure, in which a radially directed spring force is partly transformed into an axially directed spring force in a rather inefficient way, i.e. by means of springs having a plate-shaped end part with an inclined surface resting against the pin head. As only part of the spring force is used in axial direction, the spring has a surplus spring force in order to obtain a sufficient axial directed spring force. As a result the pins are unnecessarily heavily loaded by the too strong spring force, which increases the risk of deformation or even breakage of said pins.

It is an object of the invention to counteract the disadvantages of the known lighting unit as described in the opening paragrpah. The lighting unit of the type as described in the opening paragraph is for this purpose characterized in that the electrical lamp contact is hooked up with a respective holder contact. This construction of the lighting unit enables the spring force, which is caused by resilient deformation of resilient lighting unit parts, to be exerted mainly in axial direction. The word “mainly” in this context means that more than 50% of the spring force is exerted in axial direction. The resilient lighting unit parts may be, for example, the base, the support wall, electrical contact ends, holder contacts. The axially directed spring force may be obtained, for example, by a helical spring axially positioned in the holder against a holder contact, or alternatively as a result of a clamping fit of the support wall between the base and the radially projecting ends. This clamping fit is attained, for example, when the distance between the base and the radially projecting ends is somewhat smaller than the thickness of the support wall when the unit is in its final assembled position. For easily assembling in this particular example, the thickness of the support wall adjacent the openings and/or the lamp contacts may be somewhat tapered, thus enabling the radially projecting ends to hook up behind the support wall and behind the respective holder contacts upon said rotation of the lamp. The lamp contacts, which preferably are non-movably positioned at the lamp base with respect to the electric element, may form a reference location for positioning of the electric element with respect to the lamp holder. The unit thus obtained is of a relatively simple construction in which the beneficial feature of a relatively small LCL, as provided by the known lamp, is maintained. The inventive measures further achieve that the electrical contacts are not exposed to an excessive spring force, as the spring force is essentially exerted only in an axial direction. Each lamp contact may be shaped as a round pin, a flat pin, and may have a convexly shaped end for defining a well-defined line contact with a holder contact. The pins may be oriented, for example, in axial direction or in radial direction (i.e. enclose an angle with the axis of 90°) or extend away at an angle to the axis of between 0° and 90°. Each holder contact may be provided with a screw terminal for a reliable electrical connection to the outside.

In an embodiment, the lighting unit is characterized in that the outer wall surface is provided with at least one surface relief which, once the lamp and holder are assembled, fits with a matching inverse relief on the lamp base. The reliefs may be, for example, a ridge, a cross, or some other pattern on the base and a matching recess in the support wall, or vice versa. Said clamping is enhanced by the seemingly increased thickness of the support wall (or of the base wall) caused by the relief which is not snugly inside the inverse relief when the lamp and holder are not yet in the final assembled position. Once the lamp and the holder are in the final assembled position, i.e. when the relief of the base is snugly accomodated in the inverse relief of the support wall, it is further achieved that the lamp and holder are prevented from any unintended mutual back rotation due to said seemingly increased thickness. The prevention from unintended mutual back rotation may alternatively be obtained by any other combination of the shapes of the lamp contacts and the holder contacts, for example in that the holder contacts comprise a bend, a knob, a stud or rib with a shallow convex shape which abuts in a concave shape in the lamp contact, or vice versa. It is thus realized that the lamp can be rotated back, if so desired, which requires only a chosen small torque.

In a favorable embodiment, the lighting unit is characterized in that the lamp base abuts only against contours of the outer wall surface of the lamp holder. The lamp can be easily positioned with respect to the holder as it is in a snapped position when the relief and inverse relief are snugly fitted. This can be readily achieved when the relief comprises a first, a second, and a third contour which are evenly distributed over the circumference of the outer wall surface. It was surprisingly found in experiments that the electric element can be particularly accurately and readily positioned with respect to the holder when the lighting unit is characterized in that the electric element is fixedly positioned with respect to the lamp base and is further characterized in that the first contour is positioned adjacent a respective contact opening, the second and third contours are positioned such that lines extending from the holder axis through said contours have a smallest angle δ1-2 between the first and the second contour in the range of 120°<=δ1-2<=140°, a smallest angle δ1-3 between the first and the third contour in the range of 140<=δ1-3<=160° and a smallest angle δ2-3 between the second and the third contour in the range of 60°<=δ2-3≦=100°. Such an accurate positioning is of particular relevance when the electric element is to be positioned, for example, in the focal point of a reflector, said reflector in general being connected to the unit via the holder and positioned with respect to the holder. Since the electric element is accurately positioned with respect to the holder, it is thus advantageously achieved that the electric element is in an accurate position with respect to the reflector as well.

In a fIavorable embodiment, the unit is characterized in that the resilient unit parts comprise the radially projecting ends and/or the holder contacts, said parts, for example, being blade springs which are designed to exert a spring force in axial direction. The blade springs provide a larger tolerance in the distance between the base and the radially projecting ends in relation to the thickness of the support wall. Preferably, the blade springs are formed such that the blade springs are able to establish and subsequently maintain electrical contact with the ends during said rotation. As during said rotation the protruding ends follow part of a circular path with respect to the holder contacts, it is favorable that each holder contact is formed as an arc element encompassing an angle β, wherein β preferably lies in the range of 30°-150°. Each blade spring has a respective blade end by which the respective blade spring is fixed to a transverse inner wall surface of the support wall and adjacent the respective contact opening, so that the blade spring extends axially away from said inner surface at an angle α and into the housing, wherein a lies in the range of 3° to 45°, preferably in the range of 8° to 25°. An angle a smaller than 3° does not lead to a significant spring force and provides only a relatively small tolerance in the distance between the base and the radially projecting ends. If the angle α is larger than 45°, said rotation in a comfortable way is hampered and furthermore the blade springs are found to be liable to severe wear. It was found in experiments that an angle a in the range of 8-25° performed well with respect to the force exerted by the springs, wear of the springs and the contacts, and comfort and ease of the mutual rotation of the lamp and the holder.

Units, lamps or holders are very suitable for use in an optical system, component, or luminaire, for example a luminaire that is used for stage or studio lighting. Such a luminaire comprises an optical system that cooperates with the lighting unit and for which a precise alignment of the electric element with respect to reference locations in the luminaire is of particular importance. The lamp may be an incandescent lamp, for example a halogen incandescent lamp, or a discharge lamp, for example a short-arc high-pressure mercury vapor metal halide discharge lamp, or a metal halide lamp comprising a ceramic discharge vessel, for example a discharge vessel made of translucent gastight alumina.

The invention will now be elucidated in more detail with reference to a number of embodiments and a drawing, in which:

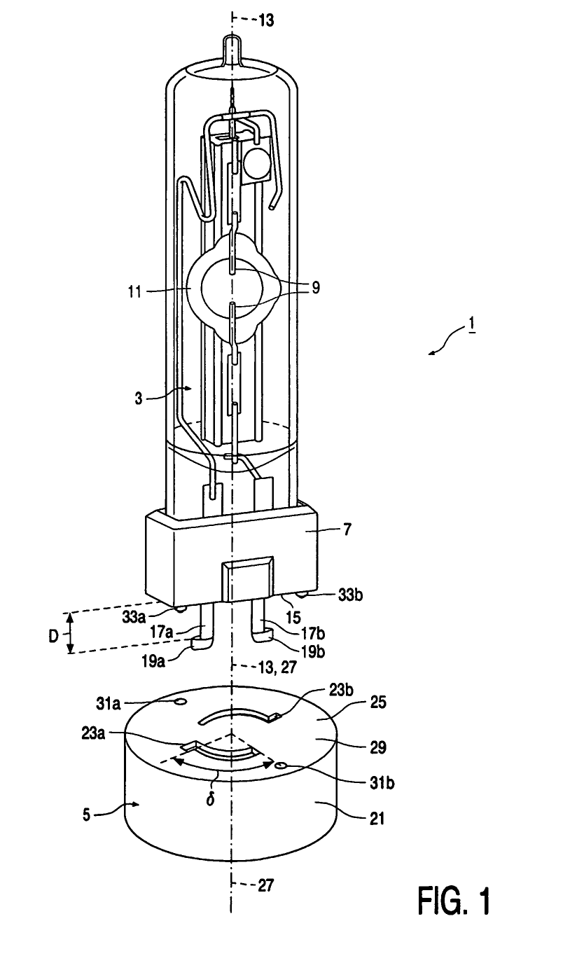

FIG. 1 is an exploded perspective view of a lighting unit according to an embodiment of the invention;

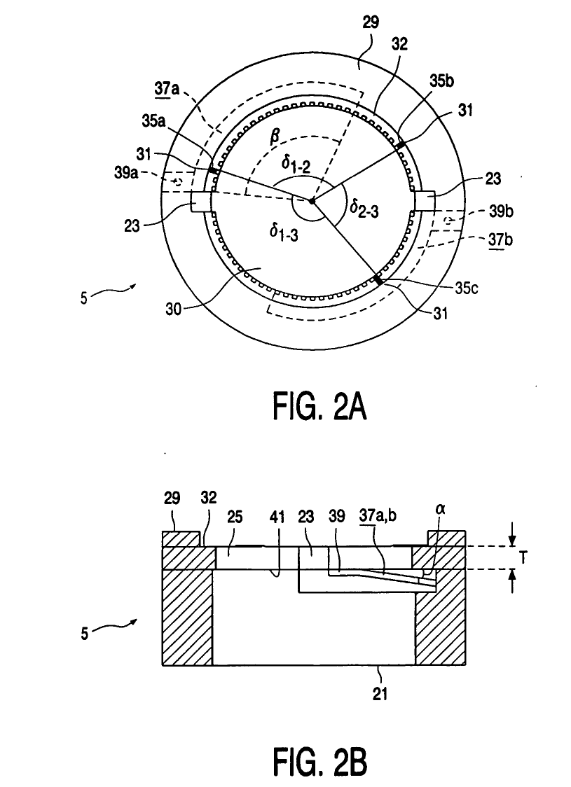

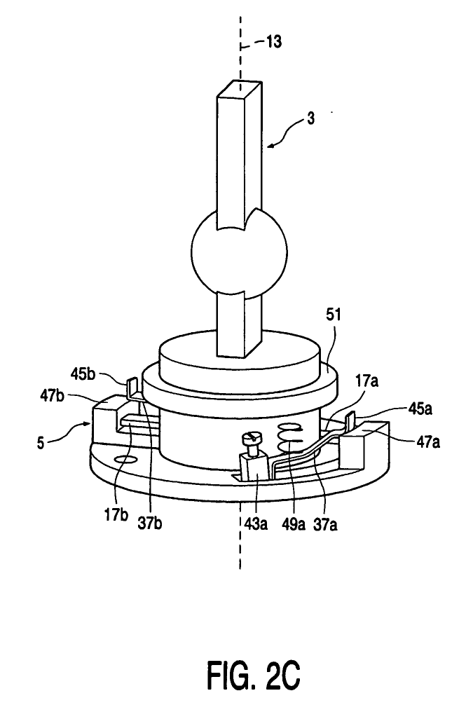

FIG. 2A is a plan view of the holder of the lighting unit according to another embodiment of the invention,

FIG. 2B is a side elevation, partly in cross-section, of the holder of FIG. 2A, and

FIG. 2C is an exploded view of the holder of FIG. 2A with a matching socketed lamp.

The Figures are purely diagrammatic and not drawn true to scale. Some dimensions are particularly strongly exaggerated for reasons of clarity. Equivalent components have been given the same reference numerals as much as possible in the Figures.

FIG. 1 shows a lighting unit 1 comprising a lamp 3 and a holder 5 in an unassembled position. The lamp comprises a socket 7, an electric element 9, a pair of electrodes in the Figure, arranged in a lamp vessel 11 mounted in the socket. A lamp axis 13 extends through the lamp vessel and the socket. The socket comprises a lamp base 15 transverse to the lamp axis, which lamp base is provided with protruding electrical lamp contacts 17a, 17b with respective radially projecting ends 19a, 19b. The holder comprises a walled housing 21 in which electrical holder contacts (not shown) are provided. The housing has contact openings 23a, 23b provided in a support wall 25 transverse to a holder axis 27, which support wall has an outer wall surface 29. The outer wall surface is provided with two surface reliefs 31a, 31b, recesses in the Figure, which, once the lamp and holder are assembled, fit with matching inverse reliefs 33a, 33b, protrusions in the Figure, on the lamp base. The support wall is retained by the ends and the electrical lamp contacts are hooked up with the respective holder contacts after insertion of the ends into the openings and subsequent rotation through an angle δ in the range of 30-150°, preferably 45-90°, in the Figure through an angle δ of about 90°, of the lamp about its lamp axis. This construction of the lighting unit enables the spring force to be exerted mainly in axial direction, which is due to resilient deformation of the base and/or the lamp contacts as a result of a clamping fit of the support wall between the base and the radially projecting ends. This clamping fit is achieved, for example, in that the distance D between the base and the radially projecting ends is somewhat smaller than the sum of the thicknesses of the support wall and the holder contact (see FIG. 2B) when the unit is in its final assembled position. Said clamping is enhanced by the seemingly increased thickness of the base wall caused by the relief which is not (yet) snugly inside the inverse relief when the lamp and holder are not in the final assembled position. Once the lamp and the holder are in the final assembled position, i.e. when the relief of the base is snugly accomodated in the inverse relief of the support wall, the lamp and holder are prevented from unintended mutual back rotation.

FIG. 2A is a plan view of a holder 5 of the lighting unit 1 according to another embodiment of the invention. The outer wall surface 29 has a seating surface 32 and further has a central opening 30 for accommodating the socket of the lamp. The seating surface 32 is provided with a surface relief 31. The relief comprises a first 35a, a second 35b, and a third contour 35c which are evenly, circumferentially distributed over the outer wall surface. The first contour is positioned adjacent a respective contact opening 23 (in the Figure integral with the central opening 30), the second and third contours are positioned such that lines extending from the holder axis through said contours have a smallest angle δ1-2 between the first and the second contour of 130°, a smallest angle δ1-3 between the first and the third contour of 150°, and a smallest angle δ2-3 between the second and the third contour of 80°. Holder contacts 37a, 37b blade springs, in the Figure are shown in a dotted line. Said holder contacts are fixed to the support wall 25 by respective blade ends 39a, 39b. Each holder contact is formed as an arc element emcompassing an angle β; in the Figure β is about 110°.

FIG. 2B is a side elevation, partly in cross-section, of the holder 5 of FIG. 2A. As is shown in the Figure, the seated surface is obtained by local recessing of the outer wall surface. The holder contacts 37 are fixed by the respective blade ends 39 to a transverse inner wall surface 41 of the support wall 25 adjacent the respective contact openings 23, the support wall having a thickness T. The blade spring extends axially away from said inner surface at an angle α of about 10° and into the housing 21. The blade springs are arc/spiral shaped and establish and subsequently maintain electrical contact with the ends during said rotation. The holder construction as shown in FIGS. 2A and 2B elucidates that the spring force, to be exerted mainly in axial direction, is achieved by resilient deformation of the blade spring holder contacts.

In FIG. 2C, the holder 5 is provided with holder contacts 37a, 37b that each comprise a screw terminal 43a and a hook 45a, 45b. Each hook abuts against a respective resting point 47a, 47b of the holder, whereby the holder contact is granted a minimum chosen height to allow the lamp contact to hook up behind the holder contact. The hook engages a recess in the holder, achieving that the holder contact is radially kept in place while allowing an axial movement of the holder contact during rotation of the lamp. The axially directed spring force of the holder contacts is provided by axially oriented helical springs 49a. The matching socketed lamp 3 is provided with radial lamp contacts 17a, 17b, i.e. the lamp contacts extend away from the lamp axis 13 at an angle of 90°. The lamp further has a circumferential flange 51 which enables simple and reliable seating of the lamp on the seating surface of the holder (see FIGS. 2A, 2B). An example of such a lamp is a CDM 20 W Hiper lamp comprising as its circumferential flange a flat glass base with electrical feedthroughs and an exhaust tube, in which flange the ceramic lamp vessel, for example made of gastight translucent aluminum oxide, is fixed and on which flange optionally a glass outer bulb is fixed by means of frit.

1. A lighting unit comprising a lamp and a holder,
the lamp comprising a socket, an electric element arranged in a lamp vessel mounted in the socket, and a lamp axis extending through the lamp vessel and the socket, the socket comprising a lamp base transverse to the lamp axis, the lamp base being provided with protruding electrical lamp contacts having radially projecting ends;
the holder comprising a walled housing in which electrical holder contacts are provided, while the housing has contact openings provided in a support wall transverse to a holder axis, the support wall has an outer wall surface, after insertion of the ends into the openings and subsequent rotation of the lamp about its lamp axis, the support wall is retained by the ends, the lamp base and the holder are pressed in axial direction towards one another by a spring force and the lamp contacts are in electrical contact with the holder contacts,
characterized in that the electrical lamp contact is hooked up with a respective holder contact.

2. A lighting unit as claimed in claim 1,
characterized in that the outer wall surface is provided with at least one surface relief which, once the lamp and holder are assembled, fits a matching inverse relief on the lamp base.

3. A lighting unit as claimed in claim 2,
characterized in that the relief comprises a first, a second, and a third contour which are cirumferentially distributed over the outer wall surface.

4. A lighting unit as claimed in claim 3,
characterized in that the electric element is fixedly positioned with respect to the lamp base, and further characterized in that the first contour is positioned adjacent a respective contact opening, the second and third contours are positioned such that lines extending from the holder axis through said contours have a smallest angle δ1-2 between the first and the second contour in the range of 120°<=δ1-2<=140°, a smallest angle δ1-3 between the first and the third contour in the range of 1400<=δ1-3<=160°, and a smallest angle δ2-3 between the second and the third contour in the range of 60°<=δ2-3≦=100°.

5. A lighting unit as claimed in claim 2, characterized in that the lamp base abuts against on the relief of the lamp holder.

6. A lighting unit as claimed in claim 1, characterized in that the unit is assembled with a reflector.

7. A lighting unit as claimed in claim 1, characterized in that resilient lighting unit parts comprise the ends and/or the holder contacts.

8. A lighting unit as claimed in claim 7, characterized in that the holder contacts are blade springs shaped so as to establish and subsequently maintain electrical contact with the ends during said rotation, each blade spring having a respective blade end by which the respective blade spring is fixed to a transverse inner wall surface of the support wall and adjacent the respective contact opening such that blade spring extends axially away from said inner surface at an angle α into the housing, wherein α lies in the range of 3° to 45°, preferably in the range of 8° to 25°.

9. A lighting unit as claimed in claim 8, characterized in that each holder contact is formed as an arc element encompassing an angle β, wherein β lies in the range of 30°-150°.

10. A holder or a lamp for use in a lighting unit as claimed in claim 1.

11. A luminaire comprising a holder or a lighting unit of claim 1.
